(19) United States
(12) Patent Application Publication
(10) Pub. No.: US 2002/0068118 A1
(43) Pub. Date: Jun. 6, 2002

(54) Hay texturizing, fortifying, and baling

(76) Inventors: John Gombos, Bakersfield, CA (US); Moshe Leasho, Huntington Beach, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/927,711

(22) Filed: Aug. 10, 2001

Related U.S. Application Data
(60) Provisional application No. 60/226,613, filed on Aug. 21, 2000.

(51) Int. Cl. A23K 1/00; B65B 13/02

(52) U.S. Cl. 426/132; 100/74; 100/18; 100/3; 426/636

(57) ABSTRACT

The invention provides texturized, baled hay or other animal fodder, preferably fortified with a flavoring or other additive. The hay is characterized by a substantial amount of long stems, substantial leaf retention, and substantial manipulation of stem structure, i.e., disruption of the lignin. Baled hay according to the invention is consistently uniform in texture, flavor, and appearance, bale after bale, for a given type or grade of hay. A machine and a method for making same are also described.

### CROSS-REFERENCE TO RELATED APPLICATION(S)

This application claims priority of Provisional Application No. 60/226,613 filed Aug. 21, 2000, the entire contents of which are fully incorporated by reference herein. Related subject matter is found in U.S. Pat. Nos. 5,927,188 and 6,202,548, the entire contents of both patents being fully incorporated by reference herein.

### FIELD OF THE INVENTION

The present invention relates to the texturizing, fortifying, and high density baling of hay.

### BACKGROUND OF THE INVENTION

A typical harvesting of hay involves cutting the hay and drying it in the field, after which it is pressed and bound into bales for easier handling and storage. Field baled hay is characterized by long stems, substantial leaf retention, and relatively little disruption of the internal stem structure, i.e., the lignin. Although field bales may be suitable for local handling and shipping, higher density hay bales are desirable for cost-effective long distance shipping. For such long distance shipping, especially to the overseas market, the hay must be packaged in high density units or bales capable of efficient packing into standard shipping containers. Efficient transportation of the hay requires that the hay bales be of substantially uniform size and weight.

One well known method for compacting hay to a high density is to create dry pellets or cubes of hay via an extrusion process. Pellets have a relatively high density, and preserve adequately as long as they are kept dry. Pellets, however, are expensive to produce. Additionally, cattle may not be able to chew or digest pellets easily, because the pellets are hard and dry. Haylage, which is fermented hay, is more palatable to livestock, and more digestible, because it is moist and tender. Haylage, however, contains a high percentage of water, causing increased shipping costs. Haylage may also spoil rapidly when exposed to air.

To ship hay economically over long distances, it has become common to double compress hay bales. That is, a standard field-baled hay is rebated into a bale of approximately one-half the prior size. Such a double compressed hay bale may reach a density of 22 pounds per cubic foot, or even higher for shipment in standard cargo containers used for overseas shipping. Bales of double compressed hay contain a substantial amount of shattered stalks, powder, and dust, as a result of the hay being repeatedly slammed against an immovable, hard surface during the high pressure baling process. Double compressed hay typically contains very few long stems. Long stems, however, are beneficial to cows, especially diary cows. Double compressed hay is less palatable to cows than is field baled hay, because the stems of double compressed hay are quite firm, and even sharp, and their leaves, being stripped from the stems, tend to fall to the bottom of feed troughs, and may not be consumed.

Another method used for high-density hay baling is the “big bale sleeve process,” in which hay is chopped to short lengths and pressed into a big nylon sleeve. The resulting hay has short stems, with little leaf retention, and the sleeve, of course, is not consumable.

A substantial amount of the nutrients in many varieties of hay is found in the leafy matter attached to the stems or stalks of the hay. Unfortunately, standard methods of compacting hay often result in the leaves being stripped from the stems. Forcefully compacting hay by pressing the hay against an unyielding object tends to sever the leafy matter from the stems. Once the hay is placed in a trough for feeding cattle, the leafy matter and, therefore, a substantial amount of the nutrients, will tend to locate in the bottom of the trough and not be eaten by the cattle. Accordingly, a means for compacting hay to increased densities while maintaining a greater amount of leaf retention than provided by conventional methods of compacting hay is desirable.

It is also desirable to achieve more uniform bales for each lot of hay passed through the baling apparatus. It is not unusual for a given field of hay to yield hay stacks of varying moisture content, color, and overall texture and appearance. When baled in a conventional manner, the hay often yields bales that are not uniform, both within each bale and from one bale to the next. In general, more uniform bales of hay are more marketable and more consumable.

It is often desirable to provide additives in hay for increasing palatability, consumability, and nutritional value. This has been done by spraying additives onto the hay as it is placed before cattle for feeding. Feed lots sometimes apply antibiotics, hormones, food supplements or flavor additives as hay is added to feed troughs. For example, molasses may be sprayed onto hay in the trough to enrich the flavor of the hay and make it more palatable. It is recognized that this can cause cattle to consume additional hay, which may be advantageous for more rapid weight gain or prolific milk production. It is desirable to provide such additives to hay more uniformly, before baling. Unfortunately, there is appreciable difficulty in applying high solids content or high viscosity additives in a uniform, homogeneous manner. Such materials are not easily sprayed and evenly distributed.

For example, molasses has a high solids content and viscosity, and is quite difficult to spray. A typical molasses is about 72% solids and 28% liquid. The high solids content, high viscosity liquid does not readily pass through small diameter nozzles, and large droplets are produced. Furthermore, such droplets tend to coalesce into larger droplets. Consequently, it is difficult to obtain uniform distribution of fortifying molasses and similar additives in the hay. Diluting the molasses to a lower solids content and viscosity helps, but is not considered a completely satisfactory solution. When the solids content of molasses is less than about 50%, molds may grow in the solution. Furthermore, it is difficult to dilute high viscosity liquids like molasses and “clumps” of difficult-to-spray liquids may remain distributed in the diluting water. Even diluted molasses uniformly, has a sufficient viscosity and solids content for retaining a short range order of the sugar molecules contained therein, such that it is not easily sprayed through fine diameter nozzles.

Accordingly, an improved means for fortifying hay with flavoring, vitamins, and other additives, in a uniform, substantially homogeneous manner, is needed. The desired end result is hay that tastes and smells better to cows, causing them to consume more hay than they would otherwise consume.

### SUMMARY OF THE INVENTION

The present invention provides texturized, baled, and (optionally) fortified hay or other animal fodder, along with a machine and a method for making same. In one embodiment, the hay is characterized by a substantial amount of long stems, substantial leaf retention, and substantial manipulation of stem structure, i.e., disruption of the lignin, and a noticeably softer texture. Baled hay according to the invention is consistently uniform in texture, appearance, bale after bale, for a given type or grade of hay. In a preferred embodiment, the hay is aromatic, being fortified with a flavoring agent such as molasses (which improves taste and/or aroma), and quite palatable to cows and horses.

The present invention also provides a method and apparatus for making texturized, baled, (and optionally) fortified hay. In one embodiment, loose hay is provided to a hopper that carries the hay on a conveyor belt toward counter-rotating “blades” or plates of a “fluffer,” which texturize the hay. Nozzles are associated with the fluffer for moisturizing the hay as required for a desired moisture content. Preferably, one or more fortifying agents—flavorings, vitamins, minerals, proteins, antibiotics, hormones, or other additives—are also added to the hay by simultaneously spraying a finely atomized mist of water droplets and fortifying agent(s), in the vicinity of the hay. A conveyor system carries the hay to a compression conduit or tunnel. The hay is forced through the conduit via a hydraulically actuated ram coupled to a pusher plate, the ram operating on a cyclical basis. As the hay is forced through the conduit by the pusher plate and ram, the cross-sectional area of the interior of the conduit is reduced by a hydraulically actuated pressure plate. Compressed hay, having a density in the range of 15 to 32 pounds per cubic foot (and, preferably, a moisture content of 9 to 15% by weight), is then baled, and the bales are cut to a predetermined size by one or more blades.

The present invention thereby provides a method of compacting hay to a high density. In doing so, the present invention also texturizes the hay to lead to increased palatability and digestibility. Moreover, the above is accomplished while providing greater levels of leaf retention than is conventionally achieved. At the same time, a flavoring or other fortifying agent is (optionally) added to the hay uniformly, thereby increasing its palatability, consumability, and/or nutritional value.

Another feature of one embodiment of the invention is the use of natural fiber twine, for example, sisal fiber twine, to bind the hay together in a bale. Natural fiber twine can be eaten by cattle, it is biodegradable, and it can even be used in bedding for cattle. Due to the high tensile strength required, such fiber has not heretofore been employed successfully in high-density baling.

These and other features of the invention will be more readily appreciated from the following detailed description and accompanying drawings.

### BRIEF DESCRIPTION OF THE DRAWINGS

FIG. 1 is a schematic view of a bale of hay according to one embodiment of the invention.

FIG. 2 is a photograph of three pieces of Sudan grass hay. The top piece 12a is from a bale of field-baled hay; the middle piece 12b is from a double compressed bale; and the lower piece 12c is from a bale made according to the present invention.

FIG. 3 is a close-up photograph of the piece of hay 12c at the bottom of FIG. 2, with the transverse striations and substantially flattened structure of the stem clearly shown.

FIG. 4 is a schematic view of the bale of FIG. 1, after it has been opened by cutting the bales' fastener(s).

FIG. 5 is a top schematic view of the hay intake hopper, fluffer, and second conveyor of one embodiment of a hay texturizing and baling machine according to the present invention.

FIG. 6 is a top schematic view of one embodiment of the ram, compression conduit, and knotter of one embodiment of a hay texturizing and baling machine according to the present invention.

FIG. 7 is a front schematic view of the counter-rotating plates or “blades” of the fluffer, part of the hay texturizing and baling machine of FIG. 5.

FIG. 8 is a transverse, cross-sectional view of a single cylinder of the fluffer of FIG. 7.

FIG. 9 is a side schematic view of the hay texturizing and baling machine shown in FIG. 6.

### DETAILED DESCRIPTION

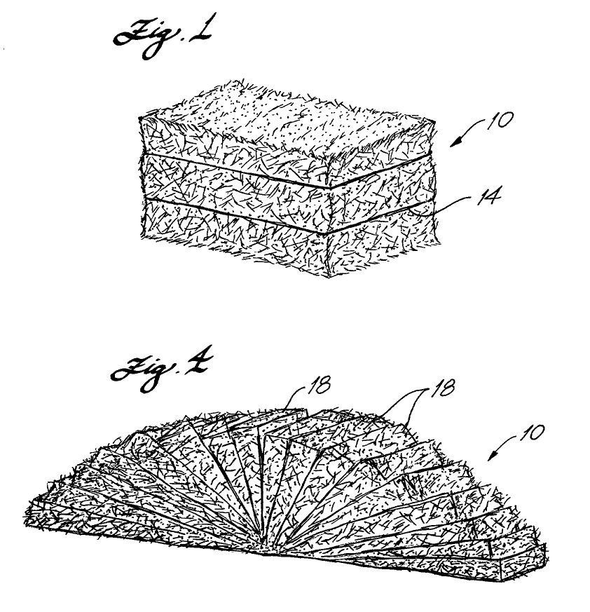

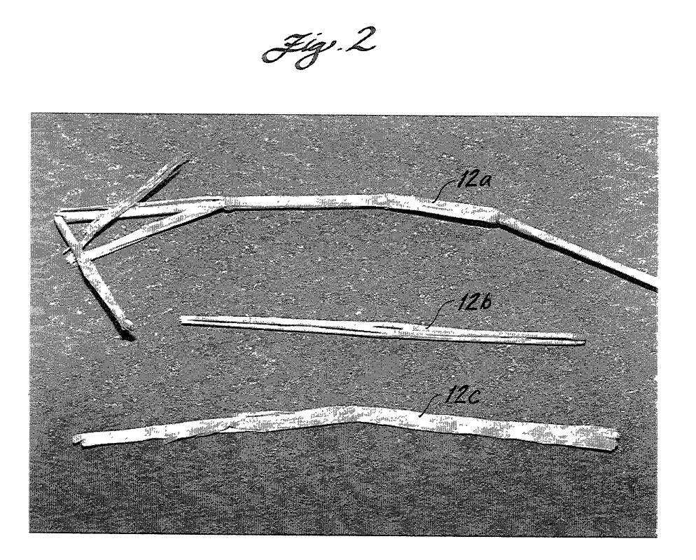

A bale of animal fodder according to one embodiment of the invention is illustrated in FIGS. 1 and 2. The bale 10 is formed of hay, straw, or other animal fodder, and essentially comprises a plurality of plant stems 12 bound by one or more fasteners 14. Nonlimiting examples of fasteners include wires, bands, and twines, which may be metal, plastic, or natural fiber. The fastener(s) should have a tensile strength sufficiently high to survive the baling process used to bind a high-density bale of animal fodder, i.e., a bale having a density of about 15 to 32 pounds per cubic foot.

In one embodiment, the fasteners are high tensile strength sisal fiber twines. Such twines are available from American Brazilian Company (AMBRACO)—ambraco.com—in a variety of lengths and tensile strengths. A presently preferred sisal fiber twine has a tensile strength of approximately 235#.

In FIG. 1, the bale has six sides and is bound by two substantially parallel twine fasteners 14. Bales having other geometric shapes, for example, right-circular cylinders, as well as bales bound with fewer or greater numbers of fasteners, are also within the scope of the invention.

It will be appreciated that most grasses, straw, and other fodder can be formed into a bale according to the present invention. A nonlimiting list includes the following: Bermuda, Sudan, oat hay, alfalfa, Bermuda straw, Kline grass, rye, fescue, timothy, orchard hay, orchard straw, bent grass, blue grass, rice straw, corn, haylage and silage. For convenience, the word “hay” is used generically herein to refer to any and all such products.

Grass stems have solid joints (nodes) and leaves arranged in two rows, with one leaf at each joint. The leaves consist of the sheath, which fits around the stem like a split tube, and the blade, which is commonly long and narrow. For convenience, the term “plant stems” is used herein to refer to grass or other plant stems, with or without attached leaves. The term is also intended to be broad enough in meaning to include “plant stalks”, which are really just large plant stems, with or without attached leaves. (Botanically, corn is classified as a grass, yet one usually refers to corn stalks, not corn stems.) Referring again to FIG. 1, the bale 10 has a number of desirable characteristics. The plant stems are compressed to a density of about 15 to 32 pounds per cubic feet, making the bale suitable for economic long distance shipping. For bales of long stem grasses, like Sudan, a majority of the stems exceed six inches in length, and a substantial number (30% or more) of the stems reach or exceed one to one and one-half feet in length, making the bale particularly beneficial to dairy cattle. A substantial number (30% or more) of the leaves attached to plant stems before machine baling remain attached after the bale is formed. A very high percentage of the stems (preferably 90% or higher) have been structurally manipulated and substantially flattened. When the stems are examined closely, it is seen that the lignin and other material that make up the interior of the stems and imparts structural strength thereto have been crushed. This makes the stem demonstrably more flexible and softer. Such flattened stems are much kinder to a cow's mouth and tongue, and much more palatable and consumable than double compressed hay, hay baled using the big bale sleeve process, and hay cubes.

Many grasses have shorter fiber lengths than Sudan grass. An example is Bermuda Straw. Hay bales of short fiber grasses typically will not have many long stems (6″ or more in length), and even fewer (if any) stems exceeding one and one-half feet in length.

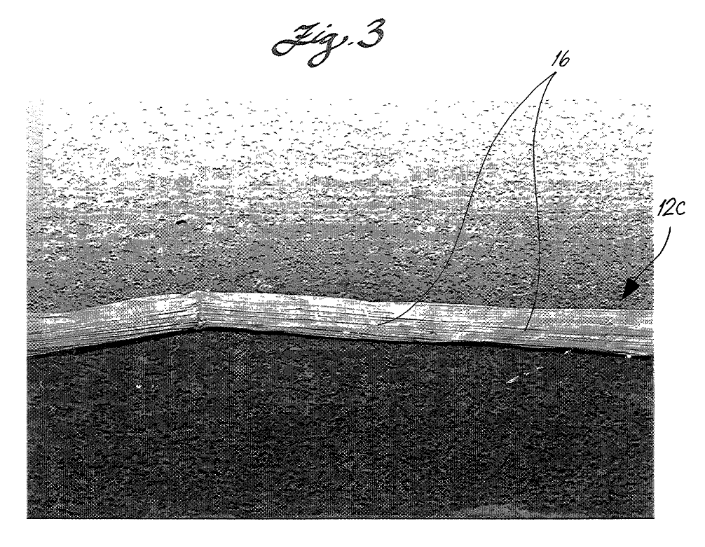

FIGS. 2 and 3 dramatically illustrate the difference between a stem of Sudan grass hay prepared in accordance with the present invention, a stem of field-baled hay, and a stem of double compressed hay. In FIG. 2, three stems of Sudan grass hay are shown. The top piece 12a is field-baled. It is over one foot long, and has several intact leaves attached to the stem. The middle piece 12b is from a bale of double compressed hay. It is substantially shorter than the piece of field-baled hay, and noticeably harder and more rigid. Few, if any, leaves remain attached to the piece. The bottom piece 12c was taken from a bale of hay prepared according to the present invention. It is demonstrably longer than the piece of double compressed hay, and substantially flattened. FIG. 3 shows a close-up photograph of this piece of hay 12c. Numerous transverse striations 16 appear all along the stem, the striations being formed during texturizing of the hay in the fluffer of the baling apparatus. This piece of hay is substantially flattened, yet is not chopped, and has leaves affixed to the stem.

Bales of hay prepared according to the present invention are generally quite uniform in appearance, texture, and (preferably) aroma, within each grade and type of fodder used. Hay from a single field, when baled using the method and apparatus described herein, will have a substantially uniform (homogeneous) appearance, both within each bale and from bale to bale. This is simply not the case with previous baling techniques. The uniformity is imparted by the fluffer through the mixing and texturizing accomplished therein and in the chimney and compression conduit of the apparatus.

An important characteristic of a preferred embodiment of a bale of hay according to the present invention is that, upon cutting the fastener(s) that bind the hay together, the bale opens up, or is easily opened up by hand, in a substantially book-like manner; that is, large mats or flakes of compressed hay fall open and apart from one another, or are easily pulled open and apart from one another, just as the pages of a book can be opened up. This is shown in FIG. 4: the bale 10 has a plurality of mats or flakes 18. This feature makes it extremely convenient for a farmer to dispense hay to cattle and other livestock. A bale of hay is offloaded from a truck or taken out of storage, and transported to a desired location; the fastener(s) of the bale are snipped; and the bale unfolds or is easily opened up by hand, at which point the farmer can grab uniform amounts of hay for distribution to livestock. This desirable “self-opening” feature results in individual flakes that are not caked, clumped, or overly heavy.

In a preferred embodiment, the baled hay has a moisture content of from about 9% to 15% by weight. When the amount of moisture in the hay is less than about 9%, the hay is somewhat brittle, and leaves break off from the stems, resulting in fine particles that sift through the hay and settle to the bottom of a feed trough where they are not readily eaten by cattle. If the moisture content is higher than about 15% by weight, the hay is likely to mildew or otherwise spoil.

In a preferred, yet optional, embodiment of the invention, at least one fortifying agent is distributed uniformly, that is, substantially homogeneously, throughout the hay. A nonlimiting example of fortifying agents includes flavorings (for example, molasses, coconut, and caramel), vitamins, minerals (for example, calcium compounds), proteins, antibiotics, hormones, and other additives that improve the nutritional or palatable qualities of the hay. The term “flavoring” is intended to refer to a substance that affects the taste and/or aroma of the hay.

Although fortifying agents are often available in liquid form, many have a substantially high solids content and may be difficult to apply by spraying. Surprisingly, it is found that spraying high solids content substances like molasses simultaneously with a fog of fine water droplets in the fluffer, results in a substantially homogeneous distribution of the additive in the hay. It is believed that the fine water droplets inhibit coalescence of the additive droplets and/or dilute the additive droplets in the aerosol present in the air. In effect, the high solids liquid is diluted in the aerosol rather than in a liquid. Furthermore, a film of water temporarily on the surface of stems and leaves of the hay may enhance mobility and distribution of additive as hay is mixed and manipulated in the fluffer (described below). Some of the water and additive droplets may be transferred as stems and leaves of the hay contact each other in the agitation of the fluffer.

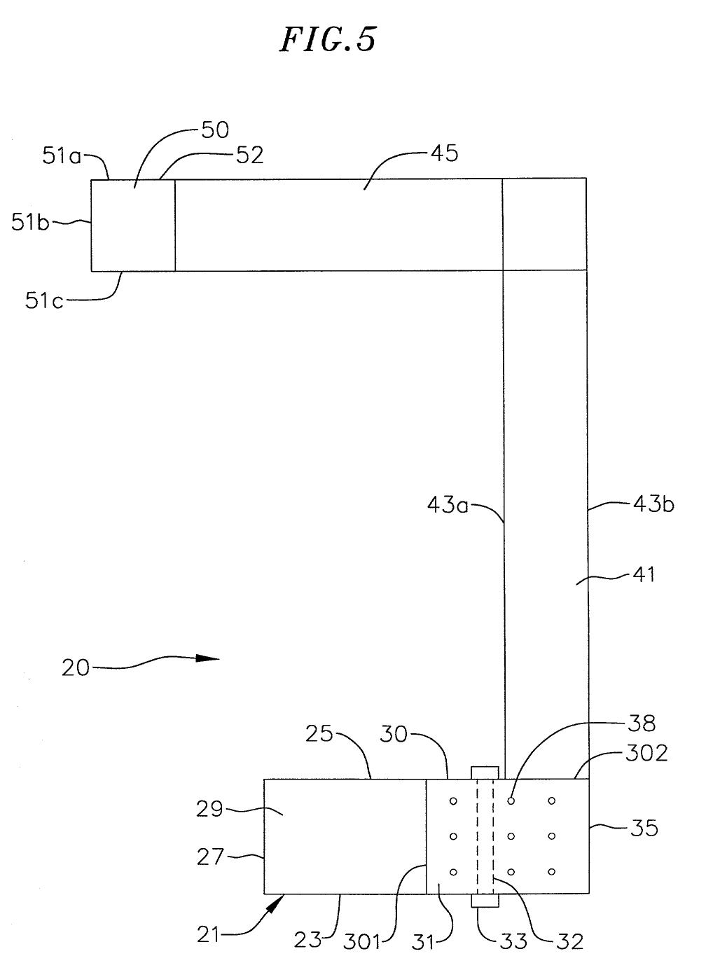

A bale of animal fodder according to the present invention is conveniently made using a texturizing and baling machine, one embodiment of which is schematically illustrated in FIGS. 5-9. Loose hay is fed into the machine 20 at a hopper 21, and is conveyed into a fluffer housing 30, where it is texturized, moisturized, and optionally, fortified with one or more flavorings or other additives. The hay may be delivered directly from the field as loose hay, or it may be from bales or rolls that have been opened prior to loading into the machine. The hay passes from the fluffer housing onto a second conveyor 41, which carries it to a compression chamber or conduit 63. In the embodiment shown, the second conveyor extends uphill and carries the hay to a third, substantially horizontal conveyor 45 that terminates in a chimney 50. The hay drops into and fills the chimney to a predetermined height. Thereafter, a hydraulic ram 81 presses the hay into a compression conduit 63, peristaltically. A plate 103 coupled to the top 65 of the compression conduit exerts pressure on the hay. A knotter 70 binds the hay bale that is formed in the compression conduit. The bale is then cut to size by one or more blades 125,126 as the bale passes out of the compression conduit.

These and other features of one embodiment of a hay texturizing and baling machine according to the invention will now be described in more detail.

The hopper 21 has two side walls 23, 25, a front 27, and a conveyor floor 29. Hay is placed on the conveyor 29 in a loose manner, preferably by mechanical means such as the use of a front loader or other mechanism. The conveyor is powered by at least one motor (not shown), and carries the hay into the fluffer housing 30.

The fluffer housing 30 shares sides 23, 25 with the hopper 21, and additionally includes a top 31 and a back wall 35. A shroud 301 closes most of the front of the fluffer except for a narrow passage near the input conveyor 29 for introducing hay into the fluffer. The outlet of the fluffer is an opening 302 into an underlying hopper defined by or situated at the proximal end of the second conveyor 41.

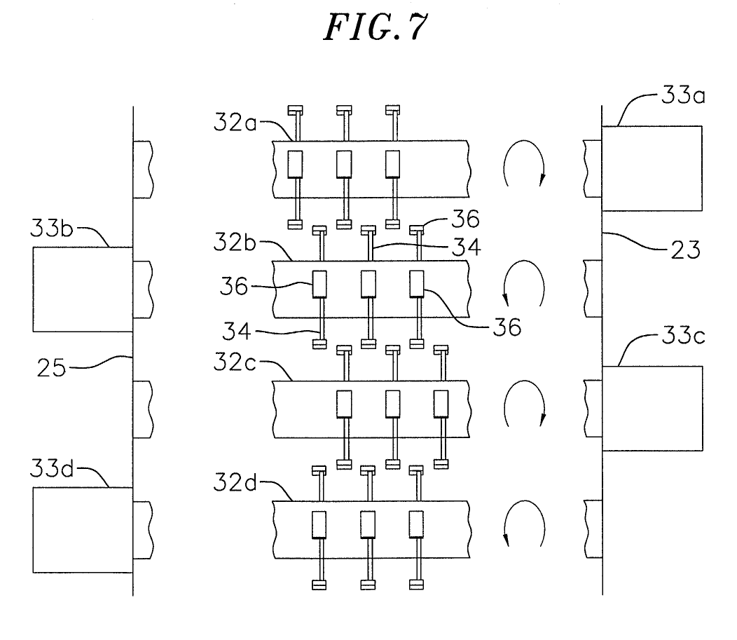

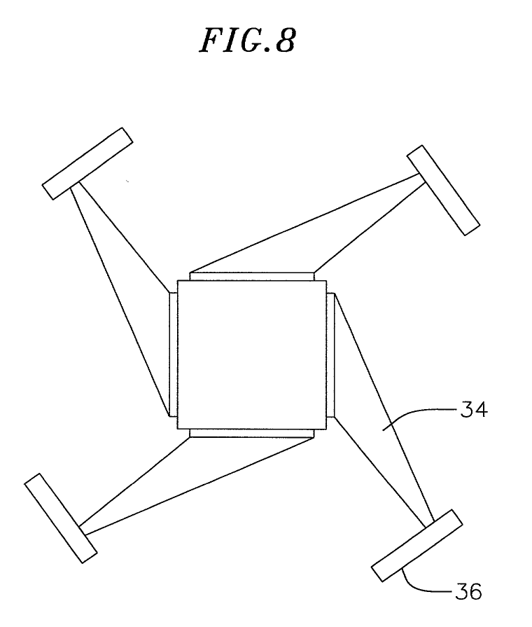

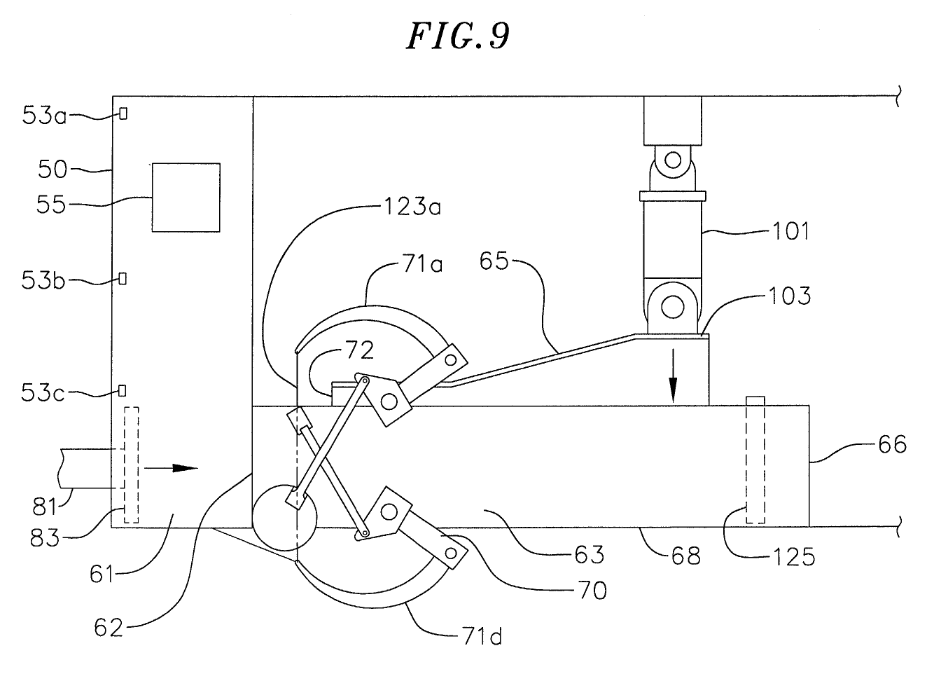

Located within the fluffer housing 30 are a plurality of rotating cylinders or drums, collectively referred to as a “fluffer” 32. The fluffer is somewhat similar to a “shredder” commercially available from Cooper Equipment, Inc., of Burley, Id., but with flat blades or plates 36 replacing the serrated blades. This minimizes the cutting action of such “blades.” More detail is shown in FIGS. 7 and 8. A plurality of cylinders 32a-d are mounted to the sides 23, 25 of the fluffer housing 30 and thereby traverse the housing. The cylinders are mounted in a vertical plane; that is, the cylinders 32a-d are mounted vertically above one another. (In FIG. 8, four cylinders are shown. In practice, three, five, or fewer or greater numbers of cylinders may be employed.)

The cylinders are powered by motors 33a-d mounted to the outside of the sidewalls 23, 25 of the fluffer housing, the motors 33a-d being coupled to the respective cylinders 32a-d. The motors for adjacent cylinders are mounted on opposite sides of the hopper for clearance. Such opposing mounting is not required, but may be beneficial based on the size of the motor housing or for providing access to the motors. It is preferred that the motors not cause the cylinders to all rotate in the same direction. Instead, the cylinders are counter-rotating, with adjacent cylinders rotating in opposing directions.

A plurality of mounting arms 34 are attached to the cylinders and extend radially therefrom. Texturizing plates or “blades” 36 are attached to the mounting arms, with the plates extending transverse to the mounting arms and substantially parallel to the main axes of the cylinders. The mounting arms are attached to the cylinders, and the plates to the mounting arms, by conventional means. Nonlimiting examples include rivets, screws, nuts and bolts, and welded joints.

FIG. 8, a transverse cross-sectional view of a portion of an exemplary cylinder 32d, illustrates the mounting arms 34 and attached plates 36. In the embodiment shown, the cylinder is square in cross-section. Alternatively, a right-circular cylinder or other configuration can be employed. A plurality of mounting arms 34 are attached to the cylinder. In one embodiment, four mounting arms are attached to the cylinder at each of many locations along the length of the cylinder. Each mounting arms extends radially from the cylinder and at 90° from adjacent mounting arms in the set. The texturizing plates 36 are substantially rectangular in shape, approximately 1 inch wide by 12 inches long by ¼ to ½ inches thick, with the plates oriented so that their length is perpendicular to the major axes of the cylinders. Alternatively, other configurations and orientations can be employed.

The plates are not sharp like the cutting knives in a shredder, and are spaced apart enough that there is minimal shearing of the hay, thereby minimizing cutting and breaking of fibers and stripping of leaves from the hay. This assures that the hay is separated from tight bundles or clumps that may have been present from a pre-existing bale, stirs the hay within the hopper, and achieves a reasonably homogeneous distribution of water and fortifying agent or agents throughout the hay. At the same time, the fluffer manipulates the stem structure of the hay and flattens the stems.

The hay stems are also somewhat separated from each other, bent, buckled and softened through contact with the texturizing blades, both singly and via the opposing contact with texturizing blades coupled to adjacent cylinders. Additionally, some of the hay undergoes multiple passes through the fluffer because adjacent cylinders are rotated in opposing directions. The bottom cylinder is rotated in a direction that tends to sweep some of the hay from the first conveyor toward the second conveyor, and some of the hay into the blades of the second cylinder, which force the hay away from the second conveyor.

Fewer or greater numbers of blades and varied spacing may be used on the rotating drums of the fluffer to obtain loosely separated hay.

Referring again to FIG. 1, a plurality of nozzles 38 for dispensing water and, optionally, one or more fortifying agents, are mounted inside the fluffer housing. Nonlimiting examples of suitable nozzles include orifice type nozzles and electrostatic dispersing nozzles. Preferred nozzles are capable of creating fine droplets (in some embodiments, even fine droplets of high viscosity and/or high solids content liquids or slurries) Particularly preferred are small orifice, high pressure (e.g., 1000 psi) nozzles made by Mee Industries, Inc. (Monrovia, Calif.).

In FIG. 1, nine nozzles are shown, each mounted to the ceiling. In practice, it is preferred to employ about 8 to 10 separate water lines, with 30 nozzles per line, mounted on the ceiling and interior walls of the fluffer housing. Each station can dispense about 0.2 gal./min. in a fine mist. Individual water lines can be opened or closed, manually or automatically, as desired to control the moisture content of the hay. Alternatively, fewer or greater numbers of nozzles and water line, mounted on the walls, ceiling, and/or even the floor of the fluffer housing, may be employed.

The nozzles 38 constitute a primary means for moisturizing the hay. In a preferred embodiment, at least some of the nozzles, or additional nozzles (not necessarily of the same design as the water nozzles), are located within the fluffer housing and dispense one or more additives simultaneously with the spraying of liquid water droplets. Preferably, the additive droplets and water droplets mix before either type of droplets encounter the hay. If the additive(s) to be applied is difficult to dispense through small orifice nozzles, larger size nozzles or electrostatic dispersing nozzles can be used. In that case, the nozzles that dispense the additive(s) are placed in close proximity to the fine atomizing water nozzles. Even high solids content fortifying agents like molasses, which typically are not easy to spray, are conveniently applied to the hay in a uniform manner by being dispensed in close proximity to very fine water droplets. In effect, the simultaneous spraying of additive droplets and water droplets creates a mixed fog that can uniformly distribute both the water and additives throughout the hay as the hay is lifted and separated (“fluffed”) by the blades of the fluffer.

In one embodiment, the water droplets have a mass mean diameter on the order of 15 to 20 micrometers. The size of additive droplets is somewhat dependent on viscosity and, in the case of molasses and other high solids content additives, is somewhat larger than the water droplets, but may be on the same order of size as water droplets for additives having a viscosity close to that of water. No detriment has been found from having additive droplets somewhat larger than water droplets. By moisturizing the hay in a uniform manner, i.e., substantially homogeneously, the formation of overly wet portions of the hay that could mildew or spoil is avoided.

The additive(s) can be supplied by a separate line or lines, or from a large vessel (e.g., a 55 gallon drum) connected to a pump and inlet line.

The amount of additive that is used depends on a number of considerations. In general, when a flavoring or other additive is introduced, it is added in a quantity sufficient to impart to the hay a desired taste, smell, nutritional value, or other property, but not so much as to raise the moisture content of the hay beyond a desirable level. It is also desirable that the imparted taste, smell, or other properties remain even after the hay has traveled overseas in a container for two weeks and, in many cases, remained stored in a warehouse for two, four, or even eight weeks. At the same time, the flavoring or other agent(s) should not be added in such quantity as to cause warehousemen to faint, or to impart a detectable taste to milk produced by cows that have been fed the hay, or to increase the cost of the hay beyond an economically viable level.

In one example of this aspect of the invention, 440 pints of molasses were used to prepare 15 standard shipping containers (each holding about 26 tons) of flavored, high density hay. This corresponds to slightly more than one pint of molasses per ton of hay. Persons skilled in the art will find that suitable quantities of flavorings and other additives can be determined by trying out different quantities, keeping in mind the parameters listed above.

It is desirable that the baled hay have a moisture content in the range of from about 9% to 15% by weight. When the amount of moisture in the hay is less than about 9%, the hay is somewhat brittle and leaves may be broken or broken off. Leaf breakage can result in fine particles that sift through the hay and settle to the bottom of a feed trough where they are not readily eaten by cattle. Keeping the maximum moisture content below about 15% by weight minimizes the possibility of mildew or other spoilage.

Additional moisture may be applied to the hay as it passes along the conveyer upstream from the fluffer and/or on the second conveyer leading from the fluffer, using a fine misting nozzle or other delivery mechanism. Adding some water at these locations can also help control dust. A fine mist or fog in the closed fluffer is preferred since moisturizing is more uniform than with water sprayed directly on the hay. Uniformity is desirable as it prevents formation of overly wet portions of the hay that may mildew.

The amount of water added to the hay is dependent on the initial moisture content of the hay, which may vary appreciably as it comes from the field. The initial moisture content can be measured, and sufficient water (including both water droplets and water in an additive solution or slurry) added to bring the moisture content of the hay into the range of from about 9 to 15% by weight. Preferably the water level in the baled hay is about 12% by weight for a maximum weight in the container without risk of spoilage.

After the hay passes through the fluffer 32, it is carried uphill by a motorized second conveyor 41, where it is deposited on a motorized, substantially horizontal, third conveyor 45, which conveys it to a chute or chimney 50. Alternatively, the hay is conveyed directly from the fluffer to the chimney, or directly to the compression conduit.

The conveyors are conventional conveyors for hay, having sidewalls, a motorized floor, and transverse bars that are dragged along the floor by roller chains at each side of the conveyor. The bars drag hay along the conveyor.

In some embodiments, at least one leveler, as described, e.g., in the '188 patent, is located on one or more of the conveyors. The leveler has a leveling cylinder mounted to the sidewalls above and transverse to the direction of motion of the conveyor. The leveling cylinder is rotated by a motor mounted to the outside of the sidewall. Four leveling beams extend radially from the leveling cylinder so as to come close to contacting the conveyor. The leveling beams thereby only allow a limited amount of hay to pass beneath the leveling beams since the direction of rotation of the leveling cylinder is such that the leveling beams move in the opposite direction from the motion of the conveyor. A limited amount of hay is also carried over the leveling cylinder by the leveling beams. This allows a substantially predetermined amount of hay to pass the leveler over a period of time. Additionally, the contact between the leveling beams and the hay may further texturize the hay. A leveler can be used, for example, to smooth out the hay before it enters the fluffer housing, after it leaves the fluffer, or as it is deposited by the uphill oriented second conveyor 41 onto the horizontal third conveyor 45.

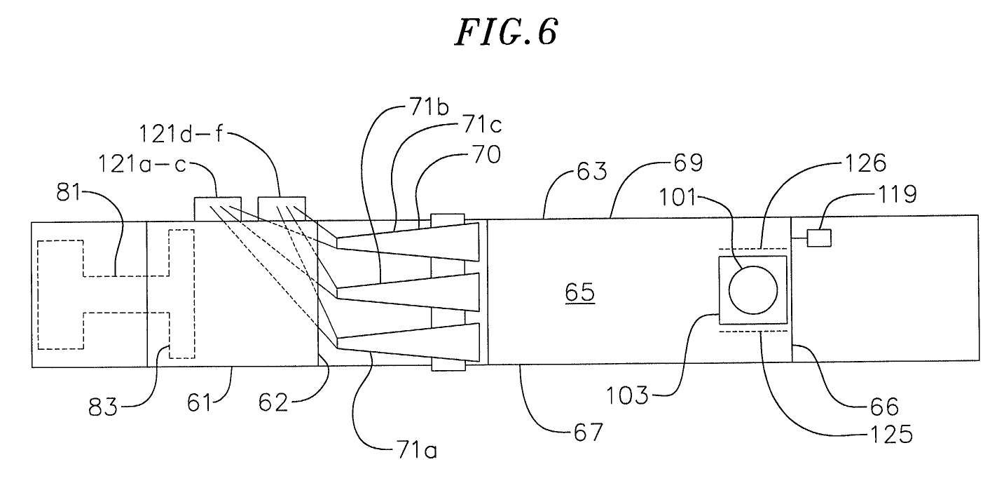

FIGS. 6 and 9 illustrate additional details of the hay texturizing machine. The chimney 50 has four side walls 51a-d, a top 52, and a bottom, the latter forming a receptacle or “second hopper” 61 for receiving hay before it is compressed in the compression conduit 63. A plurality of sensors 53a-c are placed at fixed locations along the chimney, and allow hay to be detected and thus, metered, as it is dispensed from the conveyer system into the chimney. In the present embodiment, a first sensor 53a is located just above the receptacle; a second sensor 53b is located about half way up the chimney; and a third sensor 53c is located near the top of the chimney, just below the conveyer system. The sensors operate by transmitting light across the chimney, transverse to the movement of hay within the chimney. The sensors are electrically coupled to the conveyer system and, if desired, the ram, the knotter, and other parts of the baling apparatus. Sensors are available from Allen-Bradley Company, which has an office in Long Beach, Calif. A window 55 located in one side of the chimney allows visual inspection of the hay as it falls into and fills the chimney.

Hay from the conveyer system drops down into, and begins to fill, the chimney. The level of hay in the chimney rises until it reaches the first sensor, optionally the second sensor, and optionally the third sensor. The sensors allow detection of the hay at desired heights (high, medium or low) and trigger the conveyer system to stop, thereby terminating further dispensing of hay into the chimney.

Extending from the second hopper 61 at the bottom of the chimney is a compression tunnel or conduit 63. The conduit 63 has a top 65, a bottom 68, and longitudinal sides 67, 69, which provide the conduit with a substantially rectangular cross-section. The conduit also has an upstream opening 62 adjacent to the second hopper 61, and a downstream opening 66. A knotter 70 straddles and extends through a portion of the conduit near the upstream opening 62, and provides a means for applying fasteners (e.g., wires, twine, etc.) to the bale as it is formed.

A hydraulic ram 81 is coupled to a hydraulic pump 85 along a longitudinal axis of the conduit opposite the upstream opening 62 of the conduit. The ram is capable of exerting pressures as high as 5000 PSI. Attached to the ram 81 is a pusher plate 83. As hay is fed into the second hopper 61, the ram 81, and thereby the pusher plate 83, periodically traverses the second hopper 61, thereby forcing hay into the upstream opening 62 of the conduit. As additional hay is fed into the second hopper the ram and the pusher plate cyclically forces such additional hay into the upstream opening of the conduit, and the additional hay in turn forces hay previously forced into the conduit to travel longitudinally through the conduit towards the downstream opening. The hay is moved by the pusher plate 83 in a peristaltic manner; that is, movement occurs periodically.

A plate 103 is coupled to the top 65 of the conduit towards the downstream end of the conduit. Coupled to the plate 103 is a hydraulic cylinder 101, which exerts pressure against the top plate thereby forcing the top towards the bottom. In practice, the cylinder is preferable configured to exert pressures as high as about 3000 PSI. Optionally, one or more additional plates and hydraulic cylinders (not shown) are provided at locations further downstream, and provide a means for imparting additional compressive force to the hay. In an alternate embodiment, the sides of the conduit can also be outfitted with compression plates and cylinders to impart additional compressive forces.

The top 65 of the conduit is hinged by one or more hinges 72 at or near the upstream opening 62, but allowed some inward and outward movement at the downstream opening, so as to permit some slight movement in the described directions. As the hay travels longitudinally through the conduit, additional compaction is achieved through the pressure applied by the top of the conduit. More importantly, as the hay travels through the conduit in contact with the top, bottom, and sides thereof, it encounters a frictional force oppositely directed to the motion of the hay. This frictional force resists the movement of the hay and thereby allows for greater compaction of the hay by the ram.

The pivoting of the top of the conduit as driven by the hydraulic cylinder(s) causes the top of the conduit to converge slightly in the downstream direction when the top is pressed inwardly. This convergence, and the greater normal force applied to the hay in the conduit, significantly increases the frictional force resisting advance of the hay through the conduit. In effect, the hay is being jammed into a converging passage from which it is squeezed out only with difficulty. The high pressure applied by the ram against the frictional force opposing the motion of the hay compresses the hay.

The first part of the cycle of operation is for the top of the conduit to converge toward the conduit floor. The ram and pusher plate pick up additional hay from the second hopper and press it against the hay already in the conduit. The hay is squeezed forward and compressed against the hay restricted by friction as the top converges toward the floor. The ram then retracts and the top opens up slightly, permitting the compressed hay to spring back a small amount. Some of the hay extrudes from the downstream opening of the conduit.

A sensor 119 is coupled to the top of the downstream opening 66 of the conduit. After the sensor has determined that a predetermined quantity of hay has been extruded from the downstream opening 66 of the conduit, the sensor signals the operation of a knotter 70. In the embodiment shown, the knotter is a double knotter, with a plurality of tines 71a-e located above and below the compression conduit. (Only some of the tines are shown in the figures.) The knotter is powered by a motor (not shown). A slight gap, or holes, in the top 65 of the compression conduit permit the tines 71a-f of the knotter to penetrate and traverse the growing mass of hay at a location immediately downstream of the receptacle, upstream of the conduit. Strands of wire, twine, or another fastener 123a-f are attached to the knotter at several locations transverse to the direction of travel of the hay. The strands are dispensed from rolls 121a-f mounted on the sides and/or bottom of the machine. As the knotter traverses the growing mass of hay, the strands, attached to the knotter are pushed through the hay transverse to its direction of travel. Thereafter, as the hay is forced through the conduit, the strands passed through the hay travel with the hay until a bale is formed, whereupon the knotter ties and cuts the strands, thereby forming a hay bale of a substantially predetermined size. The bale may be cut into two or more smaller bales by one or more knives 125, 126 extending through the compression conduit at or near the downstream opening 66.

The aforementioned conduit and associated devices are similar to ones commercially available from Recycle Systems of Issaquah, Wash. and described, for example, in the aforementioned '188 and '548 patents. Knotters are available from a number of companies, including Freeman and Heston, both of which have offices in Oregon. Alternate embodiments apparent to persons skilled in the art can also be employed. For example, the “gate” and “twister” configuration described in the '188 patent can be used.

The hay is compressed in a straightforward manner. On a periodic basis, with the tines of the knotter displaced out of the way, the pusher plate is driven towards the upstream opening of the conduit by the ram 81. As the pusher plate sweeps across the second hopper 61, the hay in the second hopper is forced into the upstream opening of the conduit. As the pusher plate forces hay into the upstream opening of the conduit, hay already present in the conduit is forced towards the downstream opening of the conduit and becomes compacted. This compaction does not occur through the pressing of the hay against a rigid plate, because the hay is forced directly towards the downstream opening. Instead, the hay is compacted by being pressed against a somewhat resilient mass of hay. That is, the hay already present in the second conduit provides the resistive force against which the additional hay being forced into the second conduit is pressed. That the hay is not pressed against a rigid plate provides benefits by allowing for greater leaf retention.

As previously described, the mass of hay already present in the conduit provides the resistive force against which additional hay is pressed by the ram and the pusher plate. As the hay travels from the upstream opening towards the downstream opening of the conduit, the hay is further compressed as, along any cross-section of the conduit, hay is being pressed forward by hay closer to the upstream opening and pressed against hay closer to the downstream opening. Thus, the hay is continually compacted as it travels through the conduit.

The upstream opening of the conduit provides an opening of a predetermined size, for example, 12.25″ high×45″ wide. The top 65, however, is hinged at or near the upstream opening and can be pushed toward the center axis of the conduit, so as to transversely compress the conduit and the hay therein. This movement results in the downstream opening of the conduit having a slightly smaller cross-section.

The operation of the ram 81 and the pusher 83 in forcing additional hay into the upstream opening of the conduit causes hay to extrude through the downstream opening of the conduit once the conduit is full. As the hay is extruded through the downstream opening, it contacts a sensor, such as a proximity sensor. As described in the '188 patent, one type of sensor has a wheel mounted to the top of the conduit via an L-bracket. Extending radially from the wheel are spokes. The extrusion of the hay from the downstream opening causes the wheel to rotate due to contact between the hay and the spokes. The amount of rotation of the wheel is monitored by a controller (not shown). In one embodiment, the controller comprises an SLC-500 by the Allen-Bradley Company. As the wheel has a predetermined radius, the controller is able to determine the length of the extruded block of hay. Once a predetermined amount of hay has been extruded from the conduit, the controller will stop operation of the ram and the pusher plate. The controller also signals the knotter to traverse across the longitudinal axis of the conduit for passing wires through the hay in the conduit. Upon completion of this operation, the controller reenables operation of the ram.

When the knotter tines 71a-f are forced to traverse the longitudinal axis of the conduit, they carry fastener strands from the spools through the hay present in the conduit. This causes a doubled up, or U-shaped, portion of the strands to extend through the hay. As the hay travels through the conduit, this doubled up portion of the strands of fasteners travels with the hay, causing additional strands to unspool from the spools. After a predetermined quantity of hay has been extruded through the downstream opening of the conduit, the controller will again signal the motor powering the knotter. This causes tines of the knotter to be forced through the hay, thereby forming a bale of specified length, bounded on four sides by fastener strands, which are tied off and cut by the knotter in a conventional manner.

As mentioned above, the ram 81 operates in a peristaltic manner, typically causing the pusher plate 83 to apply a series of compressive actions on the mass of hay in the conduit. At the same time, the pressure plate 103 affixed to the top of the conduit (and being actuated by the hydraulic cylinder 101) exerts a downward compressive force on the hay that builds during the compacting cycle. In practice, the ram may press the pusher plate for, e.g., six strokes, with the pressure plate 103 riding on the top surface of the mass of hay and exerting a downwardly directed pressure of, e.g., about 800, and then about 1400 PSI. On the fifth stroke, the pressure plate exerts, e.g., about 3000 PSI, at which point the knotters tie the bale. The pressure plate then returns to its original position and, on the sixth stroke, the ram/pusher plate force the formed bale out of the downstream opening of the machine.

The size, weight, and density of hay bales formed in the manner described above depends on the dimensions of the conduit, the number of slitting blades, and the amount of compaction. Bales weighing approximately 60 to 360 pounds are readily prepared using the apparatus described herein. (Even smaller or larger bales can be made by varying the conduit dimensions, number of slitting blades, etc.) The bale shown in FIG. 1 weighs about 60 pounds. If the slitting blades are removed, a bale 3 times wider is made; if desired, the bale can also be extended lengthwise (by using a longer compression conduit, or by adjusting the proximity sensor), allowing a bale 3×2 units in size (relative to the 1×1 unit size of the bale in FIG. 1) Such a bale weighs about 360 pounds.

In one embodiment of the invention, a bale has a density of approximately 27 lbs./cu. ft. More generally, when hay is baled for shipment overseas, it is formed with a density of from about 15 to 32 pounds per cubic foot. This range is desirable for obtaining optimum weight in a standard size shipping container. Ocean freight rates are based on volume rather than weight. There is a maximum weight allowance, however, for standard sized shipping containers. Thus, a minimum density of about 15 pounds per cubic foot is desirable for assuring that a filled container has an economically high total weight. If the density is less than about 15 pounds per cubic foot, one cannot normally reach the maximum weight before the volume is completely occupied. The purchaser of the hay buys it on a weight basis, so shipping the maximum weight per container is desirable, since fewer containers are needed for supplying such customers. A maximum density of about 30 to 32 pounds per cubic foot is preferred to avoid undue compression of the hay which would break too many fibers and strip leaves from the fibers.

As mentioned above, and as described in the '188 patent, it is possible to add additional compression conduits, downstream of the first conduit 63, to increase the frictional resistance encountered by the has as it moves forward. Also, additional hydraulic cylinders can be coupled to the top and/or sides of the compression conduit(s) to provide increased compressive forces. In practice, however, it has been found that a single compression conduit of about 4 to 10 feet in length, with a single hydraulic cylinder coupled to the top thereof, provides sufficient frictional resistance and compressive forces to form a bale of desired density (i.e., about 15 to 32 pounds per cubic feet).

It will be appreciated that various other ancillary parts and components (not shown) may facilitate the smooth and efficient construction and operation of the hay texturizing and baling machine thus described. For example, it is preferred to support the conveyors and other heavy components with a load-bearing frame. Power conduits, water lines, fortifying agent storage vessels and pumps, electrical control panels, hydraulic pumps and related mechanisms, lubrication mechanisms, etc., all familiar to persons skilled in the art, also can be advantageously employed. If the compression conduit is to be placed on or close to the ground, adequate clearance for the bottom tines of the knotter can be obtained by excavating a trench under same. The machine can be automatically controlled, using various station sensors that monitor and provide feedback to and from the fluffer, conveyors, ram, knotter, compression plate, etc. If needed, the automatic operation can be overridden for cleaning, clearing jams, routine maintenance, and as safety concerns arise.

Although this invention has been described in terms of specific embodiments, many additional modifications and variations will be apparent to those skilled in the art. It is therefore to be understood that this invention may be practiced otherwise than as specifically described. For example, modifications can be made to the fluffer blades or to the conduit tunnel. A combination of relatively dull “fluffer” blades and relatively sharp “shredder” blades can be employed. It is also possible to add one or more mixing bins or stations, before or after the fluffer, to allow other fodder to be introduced. Thus, a primary load of one type of hay can be processed in the baling apparatus as described herein, and a secondary load of the same or a different type of hay can be combined therewith, at one or more junctures in the apparatus. This enables one to blend different fodder —having, e.g., different stem lengths, leaf retention, moisture content, additives, etc. Thus, the described embodiments of the invention should be considered in all respects illustrative and not restrictive. The scope of the invention is defined by the appended claims.

In the claims:

1. A bale of animal fodder, comprising:
a plurality of plant stems bound by one or more fasteners; and
at least one fortifying agent distributed substantially homogeneously throughout the bale.

2. A bale of animal fodder as recited in claim 1, wherein the at least one fortifying agent is selected from the group consisting of flavorings, vitamins, minerals, proteins, antibiotics, and hormones.

3. A bale of animal fodder as recited in claim 1, wherein the at least one fortifying agent comprises a flavoring.

4. A bale of animal fodder as recited in claim 3, wherein the flavoring is molasses.

5. A bale of animal fodder as recited in claim 1, wherein the plurality of plant stems is compressed to a density of about 15 to 32 pounds per cubic foot.

6. A bale of animal fodder as recited in claim 1, wherein at least about 90% of the stems have a substantially flattened structure.

7. A bale of animal fodder as recited in claim 1, wherein a majority of the stems have a length of at least six inches and at least 90% of the stems have a substantially flattened structure.

8. A bale of animal fodder as recited in claim 1, wherein the one or more fasteners comprise wire, band, or twine.

9. A bale of animal fodder as recited in claim 1, wherein the one or more fasteners comprise sisal fiber twine.

10. A bale of animal fodder as recited in claim 1, wherein, upon cutting said one or more fasteners, the bale opens up in a substantially book-like manner.

11. A bale of animal fodder, comprising:
a plurality of plant stems compressed to a density of about 15 to 32 pounds per cubic foot bound by one or more fasteners; and
at least one flavoring agent distributed substantially homogeneously throughout the bale.

12. A bale of animal fodder as recited in claim 11, wherein the plant stems are bound by one or more sisal fiber twine fasteners.

13. A bale of animal fodder as recited in claim 11, wherein the at least one flavoring agent comprises molasses.

14. A bale of animal fodder comprising:
a plurality of plant stems bound by one or more fasteners; and
at least one fortifying agent distributed substantially homogeneously throughout the bale;
wherein, upon cutting said one or more fasteners, the bale opens up in a substantially book-like manner.

15. A bale of animal fodder as recited in claim 14, wherein the one or more fasteners comprise sisal fiber twine.

16. A bale of animal fodder, comprising:
a plurality of plant stems compressed to a density of about 15 to 32 pounds per cubic foot, bound by one or more fasteners;
wherein at least about 90% of the stems have a substantially flattened structure; and
wherein upon cutting said one or more fasteners, the bale opens up in a substantially book-like manner.

17. A bale of animal fodder, comprising:
a plurality of plant stems compressed to a density of 15 to 32 pounds per cubic foot, bound by one or more fasteners;
wherein a majority of the stems exceed six inches in length and at least about 90% of the stems have a substantially flattened structure; and
wherein, upon cutting said one or more fasteners, the bale opens up in a substantially book-like manner.

18. A bale of animal fodder as recited in claim 17, further comprising at least one fortifying agent distributed substantially homogeneously throughout the bale.

19. A bale of animal fodder, comprising:
a plurality of plant stems compressed to a density of 15 to 32 pounds per cubic foot, bound by one or more fasteners;
wherein a majority of the plant stems exceed six inches in length, a substantial number of plant stems include attached leaves, and at least about 90% of the plant stems have a substantially flattened structure; and
wherein, upon cutting said one or more fasteners, the bale opens up in a substantially book-like manner.

20. A bale of animal fodder as recited in claim 19, wherein the one or more fasteners comprise sisal fiber twine.

21. A bale of animal fodder as recited in claim 19, further comprising at least one fortifying agent distributed substantially homogeneously throughout the bale.

22. A bale of animal fodder, comprising:
a plurality of plant stems compressed to a density of 15 to 32 pounds per cubic foot, bound by one or more fasteners;
wherein a substantial number of the plant stems include attached leaves, and at least about 90% of the plant stems have a substantially flattened structure.

23. A bale of animal fodder as recited in claim 22, wherein, upon cutting said one or more fasteners, the bale opens up in a substantially book-like manner.

24. A bale of animal fodder, comprising:
a plurality of plant stems compressed to a density of 15 to 32 pounds per cubic foot, bound by one or more fasteners, wherein a substantial number of the plant stems include attached leaves, and at least about 90% of the plant stems have a substantially flattened structure; and
at least one fortifying agent distributed substantially homogeneously throughout the bale.

25. A bale of animal fodder as recited in claim 24, wherein, upon cutting said one or more fasteners, the bale opens up in a substantially book-like manner.

26. A bale of animal fodder, comprising:
a plurality of plant stems compressed to a density of about 15 to 32 pounds per cubic foot; and at least one fortifying agent distributed substantially homogeneously throughout the bale.

27. A bale of animal fodder as recited in claim 26, wherein the at least one fortifying agent is selected from the group consisting of flavorings, vitamins, minerals, proteins, antibiotics, and hormones.

28. A method for making a substantially uniform bale of animal fodder, comprising:
passing animal fodder through a fluffer comprising a plurality of counter-rotating cylinders, each cylinder having a plurality of flat plates mounted thereto;
moisturizing the fodder with water delivered by a plurality of atomizing nozzles;
forming a bale by pressing the hay into a conduit having at least one compressible face or side; and
binding the bale with at least one fastener.

29. A method as recited in claim 28, wherein the at least one fastener comprises sisal fiber twine.

30. A method as recited in claim 28 further comprising uniformly distributing at least one fortifying agent throughout the animal fodder using a plurality of atomizing nozzles.

31. A method as recited in claim 30, wherein the at least one fortifying agent is selected from the group consisting of flavorings, vitamins, minerals, proteins, antibiotics, and hormones.

32. A method as recited in claim 28, further comprising cutting the bale to a predetermined size.

33. A method for adding one or more fortifying agents to animal fodder, comprising simultaneously spraying (a) high solids content liquid or slurry containing said one or more agents and (b) water droplets of about 15 to 20 micron diameter, in the vicinity of loose hay.

34. A method as recited in claim 33, wherein total water added to the hay is sufficient to bring the moisture content of the hay to about 9% to 15% by weight.

35. An apparatus for high-density baling of animal fodder, comprising:
an intake hopper;
a fluffer downstream of the intake hopper, the fluffer comprising a plurality of counter-rotating cylinders, each cylinder having a plurality of flat plates mounted thereto;
a compression conduit downstream of the fluffer; and
a knotter for binding a bale of hay formed in said compression conduit.

36. An apparatus as recited in claim 35, further comprising a plurality of mounting arms extending from each cylinder and mounting said plurality of flat plates thereto.

37. An apparatus as recited in claim 35, wherein the plurality of counter-rotating cylinders is mounted in a fluffer housing.

38. An apparatus as recited in claim 37, further comprising a plurality of atomizing nozzles mounted inside the fluffer housing.

39. An apparatus as recited in claim 38 wherein the atomizing nozzles are adapted to dispense water.

40. An apparatus as recited in claim 38, wherein the atomizing nozzles are adapted to dispense a fortifying agent.

41. An apparatus as recited in claim 37, wherein the cylinders are mounted in a vertical plane.
